(19) United States
(12) Patent Application Publication
(10) Pub. No.: US 2010/0073149 A1
(43) Pub. Date: Mar. 25, 2010

(54) SYSTEM, APPARATUS AND METHOD FOR ENABLING OPTIMAL COMMUNICATION OVER POWER LINES

(75) Inventors: Shmuel Goldfisher, Petach-Tikva (IL); Erez Geva, Gan-Yavne (IL); Rami Refaeli, Kfar-Saba (IL)

Correspondence Address: MARTIN D. MOYNIHAN d/b/a PRTSI, INC., P.O. BOX 16446, ARLINGTON, VA, 22215, US

(73) Assignee: MainNet Comuunications Ltd, RaAnnana (IL)

(21) Appl. No.: 12/444,005

(22) PCT Filed: Oct. 8, 2007
(86) PCT No.: PCT/IL2007/001217

§ 371 Date: Apr. 2, 2009

Related U.S. Application Data
(60) Provisional application No. 60/828,642, filed on Oct. 8, 2006.

(51) Int. Cl. G05B 11/01

(52) U.S. Cl. 340/310.12; 340/310.11

(57) ABSTRACT

A system, apparatus and method for communication signaling between sending terminals and receiving terminals over power lines, comprises a power level test message configuration unit associated with a respective sending terminal for configuring test signals to send to one or more of said receiving units to determine optimal transmission characteristics for communication between the terminals, the respective test signals being configured per transmission power level. A test message sending unit sends the configured test signals to the various neighboring terminals over the power lines, therefrom to determine optimal transmission power levels for transmission to the various neighboring units.

### CROSS REFERENCE TO RELATED APPLICATIONS

The present application claims priority from U.S. Provisional Patent Application No. 60/828,642, filed Oct. 8, 2006, entitled “SYSTEM, APPARATUS AND METHOD FOR ENABLING OPTIMAL POWER LEVEL SELECTION WHEN COMMUNICATING OVER POWER LINES”, which is incorporated in its entirety herein by reference.

### BACKGROUND OF THE INVENTION

The present invention relates to electronic communication over power lines including the power lines of a national grid system, and more particularly but not exclusively to such communication by dynamic selection of optimal transmission parameters depending on the line characteristics of a given connection between sending and receiving units.

Quality transmission of data using power lines requires signals of adequate strength to be transmitted and received by network transceivers. However, due to the great variety of factors, in particular variable line characteristics in different segments of an electric grid, including different environmental factors, hardware factors, distance, quality of the wires, Electro magnetic definitions, temperature, usage of wires for other transmissions, and more, it has proven difficult to determine what such adequate levels of transmission are in power line networks.

In a power line communications system, communication may be implemented via a series of links between respective sending and receiving units. Certain communication units may be much closer to each other than others, resulting in low attenuation between the close units which contrasts with high attenuation between more distantly located units. As a result the close and distant connections may not be able to communicate or communicate adequately between them using a default transmit power level. Known systems test the link by sending a test signal. If the test signal does not get through then a higher power is used. Where spread spectrum is used the test signal may test signal to noise across the spectrum. Further, certain communication units may be located far from each other, resulting in high attenuation between the units, and optionally resulting in high transmission power levels as well. Additionally, local regulations pay provide additional constraints, by defining the transmit power level limits, which may strongly impact on the implementation of power line communications.

### SUMMARY OF THE INVENTION

The present invention relates to the determination and use of optimized or even adequate power levels when transmitting data across and within a power line environment. In some embodiments such optimization may be used to avoid bandwidth reduction at higher power levels due to saturation. In other embodiments such optimization may be used to transmit data at effective throughputs or bandwidths while maintaining selected or required power levels.

According to a first aspect of the present invention there is provided a system for communication signaling between sending terminals and receiving terminals over power lines, comprising:

a power level test message configuration unit associated with a respective sending terminal for configuring test signals to send to one or more of the receiving units to detect line characteristics from which to determine optimal transmission parameters for communication between the terminals, respective test signals being configured for one or more of a plurality of transmission power levels such that the plurality of transmission power levels are tested, and

a test message sending unit, associated with the test message configuration unit for sending the configured test signals to the one or more receiving terminals over the power lines, therefrom to determine optimal transmission power levels for transmission to respective receiving units.

In an embodiment, the line characteristics comprise at least one member of the group consisting of an attenuation characteristic, a saturation characteristic and a combined attenuation and saturation characteristic for the transmission at a given transmission power level.

In an embodiment, the member comprises a plurality of characteristics for different parts of an overall transmission spectrum.

The system may further comprise an analysis unit at the receiving terminal for analyzing the configured test signal following transmission thereof and construction or updating therefrom of a mapping of SNR against frequency for a given transmission power level, therefrom to enable signal modulation at the given transmission power level.

In an embodiment, the analysis unit is further configured to convert the mapping to an integer for comparison with other mappings.

In an embodiment, the modulation comprises spread spectrum modulation.

The system may comprise an optimization unit configured to use the mapping to select an optimal transmission power level for communication between the respective sending terminal and the given receiving terminal.

The optimization unit may be configured to select as the optimal transmission power level a power level giving a highest bandwidth per a given modulation.

The optimization unit may alternatively be configured to select as the optimal transmission power level a lowest power level giving an adequate bandwidth.

In an embodiment, the test signals are per power level, the system further comprising a priority unit for drawing up priority power levels thereby to concentrate test signals at the priority power levels.

In an embodiment, the priority unit is configured to set a most recently used transmission power level as one of the priority power levels.

According to a second aspect of the present invention there is provided apparatus for location at a communication terminal on a power transmission system, for communication signaling over the power lines, comprising:

a power level test message configuration unit for configuring test signals to send to one or more neighboring terminals to determine optimal transmission characteristics for communication with respective neighboring terminals, respective test signals being configured for one or more of a plurality of transmission power levels such that the plurality of transmission power levels are tested, and

a test message sending unit, associated with the test message configuration unit for sending the configured test signals to the one or more neighboring terminals over the power lines, therefrom to determine optimal transmission power levels for transmission to respective receiving units.

According to a third aspect of the present invention there is provided a method of communication between terminals over a power line comprising:

sending a series of test signals from a sending terminal to neighboring terminals at different transmission power levels;

from the test signals detecting line characteristics;

from the line characteristics selecting a best transmission power level for the communication.

In the method, the best transmission power level may be selected from an optimization between line attenuation and line saturation.

According to a fourth aspect of the present invention there is provided a system for communication signaling between sending terminals and receiving terminals over power lines, comprising:

a test message configuration unit associated with a respective sending terminal for configuring test signals to send to one or more of the receiving units to detect a line saturation characteristic, and

a test message sending unit, associated with the test message configuration unit for sending the configured test signals to the one or more receiving terminals over the power lines, therefrom to determine a transmission power level which is optimal for transmission to respective receiving units in view of the line saturation characteristic.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF TILE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. In the following:

FIG. 1 is a Gaussian curve graph illustrating saturation and attenuation;

FIG. 2 is a simplified diagram illustrating a system for communication over a power system according to an embodiment of the present invention;

FIG. 3 is a flow chart depicting the process of SOUND message flow and tonemap synchronization, according to some embodiments;

FIG. 4 is a flow chart depicting a method of power level optimization, according to some embodiments; and

FIG. 5 is a flow chart depicting a process of optimal transmit power level selection, according to some embodiments.

### DETAILED DESCRIPTION OF THE INVENTION

As explained in the background, the prior art sends a test message from one communication unit to another to test the line characteristics. The assumption is generally that attenuation is the only problem and if a given power level gives adequate bandwidth then so will all higher power levels since the attenuation is certainly lower. However this is not in fact the case. In some scenarios the close-together units experience a saturation problem due to the transmission power level being too high. Saturation limits the available bandwidth. To make matters worse, in many cases the saturation may affect only a part of the spectrum. Where spread spectrum is used for transmission, uneven capabilities between the different frequencies being used may result in a high transmit error rate or frame loss between the two devices. In some scenarios the saturation may cause a total disconnection between units and/or a high bit-error-rate.

According to the nature of the power line medium, which was not originally designed for communication, different topologies may create cases where a relatively small window of power level values may work sufficiently to enable adequate communication between two units. For example, lower power level values may not sufficiently communicate due to attenuation, and higher power level values may not communicate due to saturation. Embodiments of the present invention attempt to identify this window, which may be different for any pair of communication units, and may even differ for transmissions over different directions for the same communication units. Embodiments of the present invention furthermore attempt to identify the window in an efficient way, meaning so as not to jam the communication network with test signals.

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

In the following detailed description, numerous specific details are set forth in order to provide a thorough understanding of the present invention. However, it will be understood by those skilled in the art that the present invention may be practiced without these specific details.

In the following, the communication units of the present embodiments have the possibility of setting the transmitting power level (Tx). As described hereinbelow the available transmission power range may be divided up into levels and each level may be provided with an index. For example, each transmission level may be addressed as an index from 0 (lowest Tx Power level) to MAX_POWER_LEVEL_INDEX, an index that symbolizes the highest Tx Power level. The index is hereinbelow referred to as the power level or Tx power level index. The term Transmit Power Level is likewise to be understood in this way.

The communication units may be understood to include system communication modems and system communication relays.

Embodiments of the present invention enable the automated selection of optimal transmit power levels when transmitting data across power lines. In some embodiments the automated selection helps prevent saturation between neighboring communication units.

According to some embodiments, a power line communication system may be configured to operate at maximum efficiency by setting optimum power levels for data transmissions for some or all of the communication links in use, which may involve multiple or even all of the system communication modems or relays. According to some embodiments, the more effective or optimal power levels to be used for effective data transmissions may be determined and implemented on a system and/or individual modem level. According to some embodiments the power level of transmissions may be selected, determined or fixed in accordance with relevant danger levels, legal requirements, etc. As used hereinafter, power level optimization may refer to transmitting and/or receiving data at optimal levels, minimal effective power levels, regulated power levels, legal, levels, health levels or other selected power levels as required in one or more generic or specific environments.

Selection of the optimal transmission level may be achieved in a number of ways. In many cases it may be better to use the lowest effective transmission level. Such a power level saves power consumption and generates less emissions and noise at the area of transmission. However, using a trial-and-error method to find the lowest level may cause a disconnection between two communicating units, and may cause critical data to be lost. According to some embodiments, a system and method are provided to enable finding the minimal effective, and not necessarily ideal, power level value without creating a loss of data.

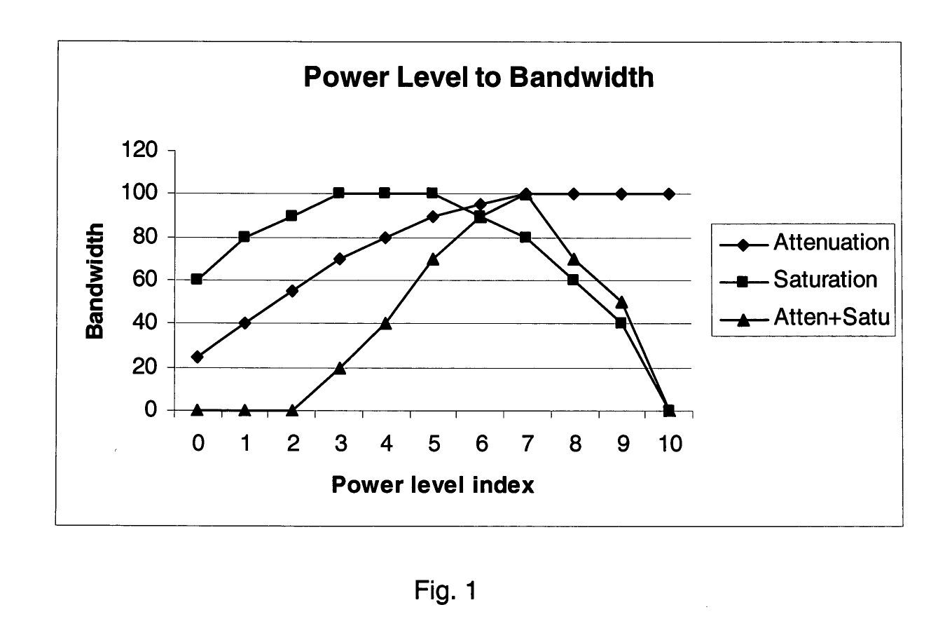

Reference is now made to FIG. 1, which is a simplified graph showing power level against effective bit rate or bandwidth. Three curves or characteristics are shown, a first is an attenuation characteristic, marked by diamonds, which rises to full power at a given power level. The second is a saturation characteristic, marked by squares, which falls beyond a certain power level and the third is the resultant of the first two, which may be approximated as a Gaussian curve. The resultant shows that there may be a limited power range which enables transmission at an effective bandwidth. Power levels both above and below the effective power range may not enable transmission of effective bandwidth.

It will be appreciated that in certain circumstances only one of the three characteristics may apply. Thus distantly located communication units may only experience, or may be dominated by, the attenuation characteristic. Closely located units may be dominated by the saturation characteristic, with attenuation playing very little part, and yet other units, where both attenuation and saturation are important, may be dominated by the resultant. Considered now in more detail, FIG. 1 indicates the different line properties according to the three scenarios. The attenuation line shows a typical attenuation scenario, in which, the higher the power level is, the higher the resulting bandwidth is. In this scenario, the bandwidth reaches 100% on power level index 7. The saturation line shows the saturation scenario, in which the bandwidth reaches 100% at power level index 3. However, after index 5 the bandwidth decreases until at a maximum index 10 there is no reception at the receiver unit. The resultant, or attenuation+saturation characteristic, shows a demonstration of attenuation and saturation in combination. In this scenario, the maximum bandwidth is achieved at index 7. Beneath this level attenuation degrades the bandwidth, and above this level saturation degrades the bandwidth level.

In general, spread spectrum transmission is used for data transmission over power lines, and spread spectrum requires transmission over a range of frequencies. At any given power level the attenuation and saturation characteristics may however vary over the range of frequencies in use. In order to optimally control the transmission power it is therefore necessary to know about the characteristic behavior over the full spectrum being used. Particular embodiments use Orthogonal frequency-division multiplexing (OFDM) modulation and Wideband OFDM (WOFDM) modulation work, to enable two units to be able to communicate data. The OFDM transmission method spreads data being communicated over a spectrum range, which is divided into transmission frequency channels or BINs. Each frequency channel is generally modulated with a simpler modulation. Furthermore, in OFDM, each transmission unit may be modulated by a different method according to the determined line signal to noise ratio (SNR). In order that a transmitter and receiver are able to understand each other and communicate, a synchronization process takes place between them, and for OFDM, SNR data is needed for each of the channels being used.

According to some embodiments, in power line communication systems, in order that a receiver is able to receive adequate transmissions, the receiver may be able to select a tone-map with the optimum or selected power level index. The term “Tonemap” as used hereinafter refers to the map showing transmission characteristics for the tones or bins that are used in the spread spectrum modulation to transfer data. In some embodiments, only tones that are good enough, meaning give adequate or optimal bandwidth to pass information with the correct modulation may be used. Selection may involve learning about the link properties between the transmitter and the receiver by sending a message using a known modulation that both the transmitter and receiver can demodulate. Such a message is referred to hereinbelow as a SOUND message. The receiver may analyze the SOUND message and calculate the SNR which the link properties from the transmitter indicate. After analyzing the result, a receiver may build up or calculate a tone map for each given power level, and if the power level is selected then the transmitter carries out a spread spectrum modulation based on frequencies shown as suitable by that tone map. The receiver, in some examples, may perform an SNR process on every received SOUND message.

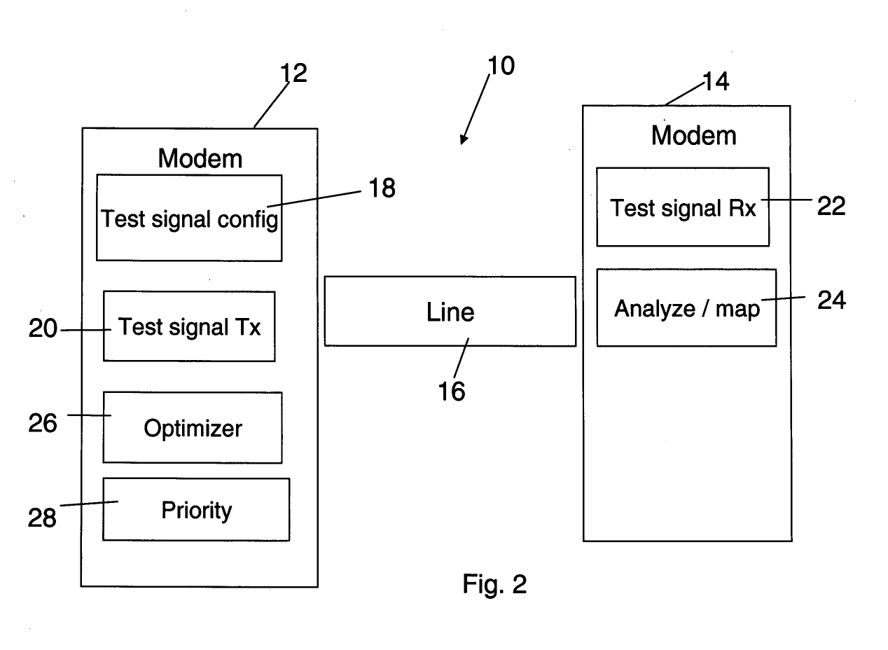

Reference is now made to FIG. 2. which is a simplified diagram showing apparatus 10 for communication signaling between sending terminals 12 and receiving terminals 14 over power lines 16. The apparatus includes a power level test message configuration unit 18, which is associated with sending terminal 12. Typically it would be located at the sending terminal, which may be a sending modem or a relay. The configuration unit 18 configures test signals to send to various potential or actual receiving units 20 to test the line characteristics and determine the optimal transmission parameters for communication between the terminals. Respective test signals are configured for given transmission power levels, and the signals as a whole test a range of power levels so that the optimal power level can be determined. The signal is then sent by a test message sending unit. The signal is affected by noise or saturation on the way and the receiving unit is able to use the result to determine transmission parameters for that power level. The operation is repeated for other power levels so that optimal transmission power levels for transmission to the respective receiving units can be identified.

Preferably the transmission parameters that are obtained by the receiver from analysis of the test signal allow an attenuation characteristic or a saturation characteristic or a combined attenuation saturation characteristic to be calculated for the transmission power level under test.

The saturation characteristic calculated for the power level may comprise two or more different saturation characteristics for different parts of an overall transmission spectrum. That is to say saturation may not be the same over the whole spectrum and therefore the frequency becomes an additional dimension to the saturation characteristic. The same applies to the attenuation and combined characteristics.

The test signal is received by receiver 22 at the communication unit that acts as the receiving link. An analysis unit 24 analyzes the configured test signal following transmission and calculates a mapping of SNR against frequency for a given transmission power level. The mapping is subsequently used both to choose a suitable power level and to modulate the signal efficiently onto the channel at the chosen power level.

Typically, modulation comprises spread spectrum modulation, however other modulation techniques may be used.

Optimization unit 26 at the transmitting terminal uses the mapping as described above. That is to say optimization unit 26 uses the mapping to select an optimal transmission power level for communication between the particular sending and receiving terminals.

The optimization unit may select a power level giving a highest bandwidth per a given modulation. Alternatively, a lowest power level giving an adequate bandwidth may be selected. Alternatively other ways of selecting a suitable power level may be chosen by a skilled person. Alternatively an otherwise selected power level may be chosen in accordance with environmental, legal/regulatory, or other factors.

The test signals themselves are per power level. It will be appreciated that at any given time, certain power levels may be more relevant than others and too many test signals could clog up the system. The apparatus 10 therefore further includes a priority unit 28 for drawing up priority power levels. Using the priority unit, test signals can be chosen to concentrate on the priority power levels, with other power levels being tested less often. Sharing schemes such as round robin based schemes described hereinbelow can be used to ensure that all power levels are tested but that the tests are concentrated on the priority levels.

In one embodiment, the priority unit is configured to set a most recently used transmission power level as one of the priority power levels.

Although FIG. 2 shows sending features in one transmission terminal and reception features in another terminal, it will be appreciated that terminals may act both as sending and receiving terminals and thus share both sending and receiving features.

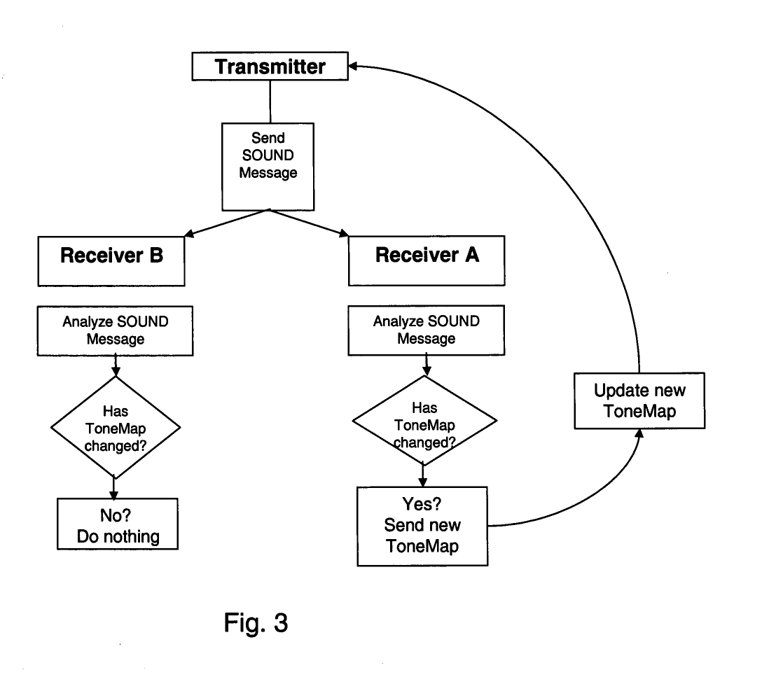

Reference is now made to FIG. 3, which is a flow chart which illustrates the use of a SOUND message as a test signal, and subsequent tonemap synchronization. As can be seen in FIG. 3, a transmitter sends a SOUND message, for example, a message that is sent in a well-known modulation which all units in the system can demodulate. Since everyone can hear it and understand it, it may be used as a common language between all units in the system, and can be used as a reference to learn the reception level of the message on the receiver side. The SOUND message may be heard by two or more receivers. Both receiver A and receiver B receive different versions of the SOUND message due to the different line characteristics involved. Receiver A analyzes the SOUND message and according to the derived SNR, may decide that a new Tone-map should be set between the transmitter and itself. Receiver A then calculates the new tonemap and sends it as an update to the transmitter. Receiver B, though, may not find any change to the synchronized tonemap, and does not perform any new synchronization.

It will be clear that, in order for the receiver to be able to synchronize with the link and create a proper tone-map, the receiver must receive a message from the transmitter. In the case of saturation or when the transmitter power level used is lower than that reception level, such a message may not in fact be received.

Additionally, the synchronized tone-map is specific to the transmitter power level usage. Since the SNR is calculated from a message of one transmission power level it is not necessarily going to be the same as the SNR for another power level. For example, using a tone-map constructed for power level X to transmit using power level Y may, in many cases, cause transmission inefficiency and high loss rate.

In certain systems many links between neighboring terminals may have their own ideal power levels which are most suitable for transmission. However, each neighbor of a given transmission terminal may have different ideal transmission power levels. An embodiment of the present invention allows such differing power levels to be configured.

It is further noted that the unit-to-unit connections may be asymmetric. Thus for example, unit A sees unit B differently from the way in which unit B sees unit A. The same may be true for power levels, where, for example, unit A may need a different power level to transmit to unit B, than unit B needs to transmit to unit A. In some embodiments the optimal power levels of units may be determined even where there are asymmetric connections. In many transmission systems, system conditions may change dramatically over time, therefore a synchronization mechanism may be provided that may enable synchronization at various predetermined or selected or even random intervals.

Further, in many transmission systems many neighboring units may exist in a given neighborhood, all needing to synchronize with each other. In order to avoid the creation of a management message overload, an optimization is provided to collect information and learn about the different connections needed. In certain embodiments system conditions may be changed in response to grid changes. In particular, changes are made in response to those grid changes which change the system behavior, in particular including radiation emission constraints which may force the system to work with specific maximum power levels.

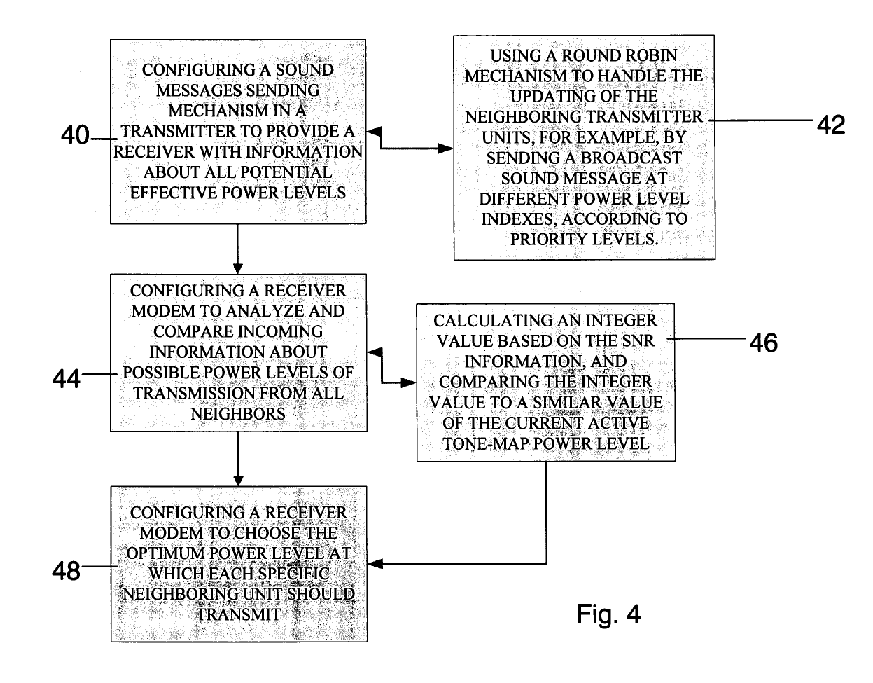

Reference is now made to FIG. 4, which is a simplified flow diagram illustrating flow in a communication system integrated into a power system to enable automated power level management for multiple communication units in the power line communication system. On the transmitter side, at stage 40, a SOUND message sending mechanism is configured to provide the receiver with information about every power level which a neighboring transmitter can use in order to reach it.

In some embodiments such power level SNR information may be enough to provide effective transmission information, yet not so much data as to cause the network to be overloaded with too many management related messages. In other cases however there is a risk of creating a high overhead for the system, for example, those systems where there are a relatively large amount of units that hear each other. In cases where every unit may be a transmitter and a receiver, and there are a large number of units overall, the resulting high usage of system resources may compromise data transmissions. In order to give a higher priority to relatively important power level indexes, a round robin mechanism or other suitable priority setting mechanisms may be used as per stage 42. Important power level indexes may be those power level indexes which are most likely the better or more optimal indexes, as for example evidenced by the most recently used power levels. These indexes are determined to be important and according to the mechanism are updated most frequently in the transmitter neighborhood. The priority power levels are preferentially tested, rather than merely selecting an index from the list of all available indexes that the system supports. In this way, the transmitter may send messages using power levels that will be more effective between the transmitter and its receivers, and/or may send more messages on more a frequent basis in order to keep the SNR and tonemaps for these indexes more accurate. These important power level indexes may be tested at a higher priority using the round robin mechanism, while the other or less important indexes are tested at lower priority using the same round robin mechanism. Accordingly, the round robin mechanism may handle the updating of the neighboring transmitter units, for example, by sending a broadcast SOUND message at different power level indexes, according to priority levels. A given SOUND message may embed the power level index at which it was transmitted, and thereby enable receivers to be able to track and differentiate between transmitted SOUND messages from the same transmitter at different power level indexes.

According to some embodiments, the round robin mechanism may assume that the most important values to be updated are the values which the transmitter has received from its near units following the tone-map synchronization process. Therefore, for example, if data is received from 8 possible indexes, only 3 of which are actually in use from the transmitting unit to its neighbors, the transmitter may keep its neighbor units' receiver side updated in order to keep the active power level tone-map up to date.

In some embodiments, in order to allow alternative power level indexes to be selected as optimal or better connections to the connected and synchronized neighbor receivers, the transmitter may use a lower priority round robin mechanism to spread that alternative power level index options to its neighbors. Such a low priority mechanism may also be used to allow neighbor receivers to be able to synchronize to the transmitter, for example, in cases where only a single power level index is possible between transmitter and receiver at any given time.

In certain embodiments, in order to generate the prioritization of the power level indexes, each transmitter may maintain a counter for each possible power level index. Each transmitter may use its synchronized neighbors' tone-maps information, which includes the power level it was synchronized with, in order to count the number of neighbors for any given power level index. Using this count information, the transmitter may choose to transmit SOUND messages on the high-priority round-robin only on power levels that are currently in use. In cases where all power level indexes are being used, the transmitter may set a dynamic threshold and use the counter for deciding which indexes are above the threshold and should therefore be included on the high priority list.

According to some embodiments, after a selected number of transmissions of high priority list rounds of SOUND messages, the transmitter may perform a round of all possible indexes, including say unused indexes, in order to give all synchronized and unsynchronized neighbors a possibility to choose a better power level index from all the levels available.

In certain embodiments the order of indexes to be used, either on high priority rounds and/or low priority rounds, may be determined using a step approach, for example, by moving from one index to the index above it. In other embodiments, in order to keep neighboring units updated and/or in order to shorten the time for new neighbors to be synchronized, each step may include a jump of several indexes. An index jump may be chosen as a number that is not a factor or a multiple of the maximum power level index (MAX_POWER_LEVEL_INDEX) value. In such a case, the full range is stepped over fairly quickly and eventually all possible values are passed once and the round is completed. Using such a step method may be advantageous since each receiver may obtain more levels in the range of the power level spectrum faster.

For example: if MAX_POWER_LEVEL_INDEX equals 7, starting from a minimal value which is 0, the STEP value may be defined as 3, using the formula of: Current_Index=Index+STEP % MAX_POWER_LEVEL_INDEX. This may provide a full round of the following indexes: 0, 3, 6, 1, 4, 7, 2, 5.

In the above example, the system supports 10 power level indexes. The transmitter unit may have a synchronized connection with 8 neighbor receivers. The Tone-map power levels counter table may include, for example:

| Neighbor unit ID: | Power Level index: |
|---|---|
| 00-03-6A-00-00-01 | 6 |
| 00-03-6A-00-00-02 | 9 |
| 00-03-6A-00-00-03 | 4 |
| 00-03-6A-00-00-04 | 6 |
| 00-03-6A-00-00-05 | 9 |
| 00-03-6A-00-00-06 | 5 |
| 00-03-6A-00-00-07 | 9 |
| 00-03-6A-00-00-08 | 6 |

The resulted Power level index counter table may include, for example:

| Power Level index | Counter |
|---|---|
| 0 | 0 |
| 1 | 0 |
| 2 | 0 |
| 3 | 0 |
| 4 | 1 |
| 5 | 1 |
| 6 | 3 |
| 7 | 0 |
| 8 | 0 |
| 9 | 3 |

In the above example the STEP value is 7, the ratio is 1 low priority indexes cycle to 2 high priority indexes cycles in a single round, and hence, the full cycle of power level SOUND messages sending mechanism may use the following power level indexes:

(Round 1 —high priority): 4, 5, 9, 6

(Round 2 —high priority): 4, 5, 9, 6

(Round 3 —low priority): 0, 7, 4, 1, 8, 5, 2, 9, 6, 3

Referring now to box 44, as explained above, in some embodiments the unit which sets the tone-map and the power level at which a transmitter transmits to a specific receiver may be set by the receiver during the tone-map synchronization process. In order that the receiver is able to select the optimum tone-map with the optimum or selected power level index, the receiver may be configured to analyze and compare incoming information about possible levels of power transmission from all neighbors. In some embodiments for example the receiver may perform the SNR process on every received SOUND message. In some cases, however, keeping SNR information per all possible power level indexes may be challenging due to limited resource in the embedded devices. Further, comparisons using all SNR related information can be complex and inefficient.

As shown in stage 46, a method is provided to calculate an integer value, based on the SNR information. Unlike the SNR information itself, the integer does not take much space in the RAM memory. The calculated integer value is hereinafter referred to as the SNR_MARK. Thus, when a receiver obtains a SOUND message from a transmitter, then, after performing the SNR analysis process, the receiver may calculate the SNR_MARK value and compare it to the SNR_MARK of the currently active tonemap. If the new SNR_MARK is an improvement over the current SNR_MARK and/or the active tone-map value, the receiver may perform tone-map resynchronization. The power level having the better SNR_MARK is then set as the active power level at the transmitter.

In another embodiment, the receiver may store all SNR_MARK values per possible power level indexes. Then, in cases where the active power level performances have decreased, the receiver may switch over to the next-in-line power level index, which now has the maximum value. The same may be calculated using the actual SNR information, if the system has enough resources to store the actual information.

In one embodiment the receiver may use a request-to-synchronize protocol that indicates a power level for which information is required. The protocol is used to cause the transmitter to send a SOUND message at the indicated power level index, and the SOUND message obtained as a result is then used by the receiver to create an updated SNR, from which an updated tone-map is generated.

The SNR_MARK is, as explained above, an integer value indicating the quality of the SNR calculated from the received SOUND message. In order to calculate the SNR_MARK value, a calculation formula may be used which involves the stages of:

1) setting the matching modulation theoretical bandwidth, for example, which may be a result of the signal to noise ratio on each bin from the spectrum. Higher noise ratios may force usage of low rate modulation over a specific bin.

2) calculating a neighbor's relationship parameter, a parameter which determine the differentiation between neighboring bins. Thus, a low differentiation may indicate that the link is relatively clean of noise and saturation effects. Lower delta values between near SNR bins may indicate that the derived tone-map will perform better.

3) including an indication of SNR values. For example, low SNR values on multiple bins may indicate link problems and high error rates between Transmitters and Receivers. Trying to bypass such low SNR frequencies by not modulating anything on the matched frequencies of these bins may cause relatively high error rates over the transmission as a whole. The lower level which defines a low SNR bin is defined as SNR_LOW_THRESHOLD.

In order to include each of the above three parameters in a meaningful SNR_MARK value, several terms are used, which may be defined as follows:

1) SUM, which is the summation of all SNR values of the bins. The SUM gives the total theoretical bandwidth of the link's SNR.

2) DELTA, which is the summation of all delta calculations between neighbor bins. DELTA gives the total differentiation level of the SNR over the link;

3) LOW_COUNT, which is the total number of bins with SNR value lower than SNR_LOW_THRESHOLD. This may provide the number of “barriers” that help provide a good communications link.

Two other Constant (CONST) values are defined, which may set the weight at which DELTA and LOW_COUNT will affect the SNR_MARK. These values may be defined as CONST1 and CONST2.

According to some embodiments, a formula for calculating the SNR_MARK is:

SNR_MARK=SUM−[(DELTA*CONST1)*SUM]−[(LOW_COUNT*CONST2)*SUM]

According to other embodiments, a formula for calculating the SNR_MARK is:

SNR_MARK=SUM−(DELTA*CONST1)−(LOW_COUNT*CONST2)

Other formulas or algorithms that may generate required results may be used.

In some embodiments, where there is a higher SNR_MARK value per power level, a receiver may choose the power level index with the highest SNR_MARK value. Such a power level index may be assumed to be the optimal power level index.

In a system where there is an SNR_MARK preference for higher power levels, a parameter POS_SROUND may be defined. POS_SROUND sets the round value at which the receiver chooses a higher power level index, above the power level index with the currently highest SNR_MARK. The selected index may be determined to be within the range of the maximum SNR_MARK-POS_SROUND. This implementation, for example, may be used when the goal is to transmit with the highest possible power level index, while avoiding saturation.

In some embodiments, where the SNR_MARK preference is to a lower power level, a parameter NEG_SROUND may be defined. NEG_SROUND may be set according to a round value at which the receiver utilizes a lower power level index, namely an index which is beneath the power level index with the currently highest SNR_MARK. This parameter may be determined to be within the range of the maximum SNR_MARK-NEG_SROUND. This implementation may be used, for example, to transmit data with the lowest possible power level index, while avoiding performance degradation.

Due to the dynamic characterization of the power line media, there may be certain cases when the link properties change rapidly. In extreme cases, a link that worked well on a certain power level index may change such that the certain power level index is no longer workable. Thus, SOUND messages may not be received by the receiver unit—causing the SNR_MARK value currently held regarding the particular index to be inaccurate. In some embodiments an aging mechanism may be used, according to which the receiver retains a time-tag of the most recent updated of the SNR_MARK of a certain index. After a period during which no SOUND messages have been received on the index, the SNR_MARK may be erased. Such an erasure may represent a disconnection in the given power level index.

Finally, in stage 48, the receiving terminal may be configured to choose the optimum or otherwise selected power level at which each specific neighboring unit should transmit, for subsequent communications with the specific neighboring unit that originally sent the test signal. The receiving terminal may thereby use different power levels for communicating with different neighbors.

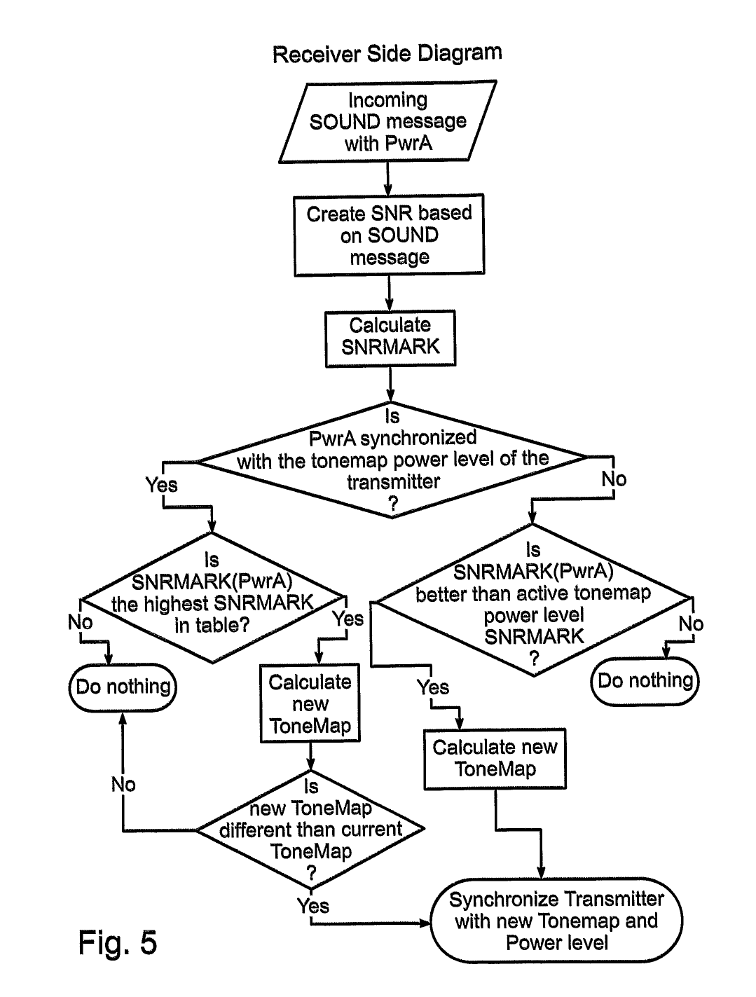

Reference is now made to FIG. 5, which is a simplified flow chart showing the receiver side operations. The receiver may receive an incoming SOUND message with an initial Power level (PwrA). The receiver may then generate an SNR calculation for the received power level, based on the SOUND message. The receiver may use the SNR calculation to generate a SNR_MARK calculation, to determine transmission quality and bandwidth. If the initial power level produces a power level (PwrA) that is synchronized with the tonemap power level of the transmitter, the receiver may determine whether the SNR_MARK is the highest score in a SNR_MARK table. If it is, a new tonemap may be generated. The receiver may further determine whether the new tonemap is different from the current tonemap. If it is not, no action need be taken. If on the other hand, the new tonemap is different, then the transmitter may be synchronized with the new tonemap and power level. If the newly calculated SNR_MARK is not the highest score in a SNR_MARK table, then this power level is most likely not of interest and nothing need be done.

If the initial power level produces a power level (PwrA) that is synchronized with the tonemap power level of the transmitter, the receiver may determine whether the SNR_MARK is better than an active tonemap power level SNR_MARK. If the SNR_MARK is better, the receiver may calculate a new tonemap, and further synchronize the transmitter with the new tonemap and power level. If it is not better, the receiver need not take any action. The receiver may further determine whether the new tonemap is different from the current tonemap. If it is not, no action need be taken.

Any combination of the above steps may be implemented. Further, other steps or series of steps may be used.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. System for communication signaling between sending terminals and receiving terminals over power lines, comprising:
a power level test message configuration unit associated with a respective sending terminal for configuring test signals to send to one or more of said receiving units to detect line characteristics from which to determine optimal transmission parameters for communication between said terminals, respective test signals being configured for one or more of a plurality of transmission power levels such that said plurality of transmission power levels are tested, and
a test message sending unit, associated with said test message configuration unit for sending said configured test signals to said one or more receiving terminals over said power lines, therefrom to determine optimal transmission power levels for transmission to respective receiving units.

2. System according to claim 1, wherein said line characteristics comprise at least one member of the group consisting of an attenuation characteristic, a saturation characteristic and a combined attenuation and saturation characteristic for said transmission at a given transmission power level.

3. System according to claim 2, wherein said member comprises a plurality of characteristics for different parts of an overall transmission spectrum.

4. System according to claim 1, further comprising an analysis unit at said receiving terminal for analyzing said configured test signal following transmission thereof and construction or updating therefrom of a mapping of SNR against frequency for a given transmission power level, therefrom to enable signal modulation at said given transmission power level.

5. System according to claim 4, wherein said analysis unit is further configured to convert said mapping to an integer for comparison with other mappings.

6. System according to claim 4, wherein said modulation comprises spread spectrum modulation.

7. System according to claim 6, further comprising an optimization unit configured to use said mapping to select an optimal transmission power level for communication between said respective sending terminal and said given receiving terminal.

8. System according to claim 7, wherein said optimization unit is configured to select as said optimal transmission power level a power level giving a highest bandwidth per a given modulation.

9. System according to claim 7, wherein said optimization unit is configured to select as said optimal transmission power level a lowest power level giving an adequate bandwidth.

10. System according to claim 1, wherein said test signals are per power level, the system further comprising a priority unit for drawing up priority power levels thereby to concentrate test signals at said priority power levels.

11. System according to claim 10, wherein said priority unit is configured to set a most recently used transmission power level as one of said priority power levels.

12. Apparatus for location at a communication terminal on a power transmission system, for communication signaling over said power lines, comprising:
a power level test message configuration unit for configuring test signals to send to one or more neighboring terminals to determine optimal transmission characteristics for communication with respective neighboring terminals, respective test signals being configured for one or more of a plurality of transmission power levels such that said plurality of transmission power levels are tested, and
a test message sending unit, associated with said test message configuration unit for sending said configured test signals to said one or more neighboring terminals over said power lines, therefrom to determine optimal transmission power levels for transmission to respective receiving units.

13. Apparatus according to claim 12, further comprising an analysis unit for receiving test signals from neighboring terminals for analyzing said configured test signal following transmission thereof and construction or updating therefrom of a mapping of SNR against frequency for a given transmission power level, therefrom to enable signal modulation at said given transmission power level.

14. Apparatus according to claim 13, wherein said modulation comprises spread spectrum modulation.

15. Apparatus according to claim 12, further comprising an optimization unit configured to use said mapping to select an optimal transmission power level for communication with said neighboring terminal.

16. Apparatus according to claim 15, wherein said optimization unit is configured to select as said optimal transmission power level a power level giving a highest bandwidth per a given modulation.

17. Apparatus according to claim 15, wherein said optimization unit is configured to select as said optimal transmission power level a lowest power level giving an adequate bandwidth.

18. A method of communication between terminals over a power line comprising:
sending a series of test signals from a sending terminal to neighboring terminals at different transmission power levels;
from said test signals detecting line characteristics;
from said line characteristics selecting a best transmission power level for said communication.

19. The method of claim 18, wherein said best transmission power level is selected from an optimization between line attenuation and line saturation.

20. System for communication signaling between sending terminals and receiving terminals over power lines, comprising:
a test message configuration unit associated with a respective sending terminal for configuring test signals to send to one or more of said receiving units to detect a line saturation characteristic, and
a test message sending unit, associated with said test message configuration unit for sending said configured test signals to said one or more receiving terminals over said power lines, therefrom to determine a transmission power level which is optimal for transmission to respective receiving units in view of said line saturation characteristic.
